(19) United States
(12) Patent Application Publication
(10) Pub. No.: US 2025/0059815 A1
(43) Pub. Date: Feb. 20, 2025

(54) GRAVITY COMPENSATION IMPROVEMENT FOR POWER CLOSURE MEMBER MOTION CONTROL

(71) Applicant: MAGNA CLOSURES INC., Newmarket (CA)

(72) Inventor: Ryan HERMAN, Newmarket (CA)

(21) Appl. No.: 18/806,909

(22) Filed: Aug. 16, 2024

Related U.S. Application Data
(60) Provisional application No. 63/532,960, filed on Aug. 16, 2023.
(60) Provisional application No. 63/619,119, filed on Jan. 9, 2024.

(51) Int. Cl. E05F 15/70; E05F 15/611

(52) U.S. Cl. CPC E05F 15/70; E05F 15/611; E05Y 2400/32; E05Y 2400/446; E05Y 2900/531

(57) ABSTRACT

A power closure member actuation system for moving a closure member of a vehicle is provided. The system includes an actuator configured to move the closure member relative to a vehicle body and a closure member accelerometer configured to determine a steady state gravitational force on the closure member according to an orientation of the vehicle. A controller is configured to determine the steady state gravitational force on the closure member using the closure member accelerometer while the closure member is in a predetermined position and is not moving. The controller is also configured to control movement of the closure member by the actuator to compensate for variable gravitational forces on the closure member during movement of the closure member. The variable gravitational forces used to control the movement are predetermined and selected according to a position of the closure member and the steady state gravitational force.

### CROSS-REFERENCE TO RELATED APPLICATIONS

This application claims the benefit of U.S. Provisional Application No. 63/532,960 filed on Aug. 16, 2023 and titled “Gravity Compensation Improvement for Power Closure Member Motion Control”, and U.S. Provisional Application No. 63/619,119 filed on Jan. 9, 2024 and titled “Gravity Compensation Improvement for Power Closure Member Motion Control”. The entire disclosure of the above applications are incorporated by reference herein in their entirety.

### FIELD

The present disclosure relates generally to closure member systems for motor vehicles and, more particularly, to a power closure member actuation system for moving a closure member, such as a vehicle door, relative to a vehicle body between an open position and a closed position.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define the pivot axis. Such swinging passenger doors (“swing doors”) have recognized issues such as, for example, when the vehicle is situated on an inclined surface and the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding the door in one or more mid-travel positions in addition to a fully-open position. In some high-end vehicles, the door hinge may include an infinite door check mechanism which allows the door to be opened and held in check at any desired open position. One advantage of passenger doors equipped with door hinges having an infinite door check mechanism is that the door can be located and held in any position to avoid contact with adjacent vehicles or structures.

As a further advancement, power closure member actuation systems have been developed. For passenger doors, like those described above, the power closure member system can function to automatically swing the passenger door about its pivot axis between the open and closed positions, to assist the user as he or she moves the passenger door, and/or to pop out or present the passenger door to the user. Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Schuering et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

While such power closure member actuation systems function satisfactorily for their intended purpose, one recognized drawback relates to sensing inclination or orientation of the vehicle and compensating for the effects of gravity on the closure members when moving the closure members. Specifically, numerous sensors and significant processing may be needed to provide such compensation.

In view of the above, there remains a need to develop alternative power closure member actuation systems which address and overcome limitations and drawbacks associated with known power closure member actuation systems as well as to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a power closure member actuation system for moving a closure member of a vehicle between an open position and a closed position relative to a vehicle body. The power closure member actuation system includes an actuator coupled to the closure member and the vehicle body configured to move the closure member relative to the vehicle body. The system also includes at least one closure member accelerometer configured to determine a steady state gravitational force on the closure member according to an orientation of the vehicle. A controller is in communication with the at least one closure member accelerometer and the actuator. The controller is configured to determine the steady state gravitational force on the closure member using the at least one closure member accelerometer while the closure member is in a predetermined position and is not moving. The controller is also configured to control movement of the closure member by the actuator to compensate for variable gravitational forces on the closure member during movement of the closure member. The variable gravitational forces used to control the movement are predetermined and selected according to a position of the closure member and the steady state gravitational force.

It is a further aspect of the disclosure to provide a method of controlling movement of a closure member of a vehicle between open and closed positions relative to a vehicle body using a power closure member actuation system. The method includes the step of determining a steady state gravitational force on the closure member according to an orientation of the vehicle using at least one closure member accelerometer while the closure member is in a predetermined position and is not moving. The method also includes the step of controlling movement of the closure member by an actuator coupled to the closure member and the vehicle body to compensate for variable gravitational forces on the closure member during the movement of the closure member. The variable gravitational forces used to control the movement are predetermined and selected according to a position of the closure member and the steady state gravitational force.

It is yet another aspect of the disclosure to provide a power closure member actuation system for moving a closure member of a vehicle between an open position and a closed position relative to a vehicle body. The power closure member actuation system includes an actuator coupled to the closure member and the vehicle body configured to move the closure member relative to the vehicle body. The power closure member actuation system additionally includes a compass and at least one closure member accelerometer configured to determine a steady state gravitational force on the closure member according to an orientation of the vehicle. The power closure member actuation system also includes a controller in communication with the compass and the actuator and the at least one closure member accelerometer, the controller configured to determine the position of the closure member using the compass.

It is yet another aspect of the disclosure to provide a control system for power closure member actuation system for moving a closure member of a vehicle between an open position and a closed position relative to a vehicle body. The control system includes a controller configured to control an actuator coupled to the closure member and the vehicle body configured to move the closure member relative to the vehicle body. A closure member accelerometer is configured to output an accelerometer signal to the controller indicative of an inclination of the closure member. The controller is adapted to compensate for a change in the inclination of the closure member during controlling the actuator to move the closure member using the accelerometer signal acquired during a steady state of the closure member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and the vehicle body according to aspects of the disclosure;

FIG. 2 is a perspective inner side view of a closure member shown in FIG. 1, with various components removed for clarity purposes only, in relation to a portion of the vehicle body and which is equipped with the power closure member actuation system according to aspects of the disclosure;

FIG. 2A illustrates a detected change in measured angular positions of the closure member using a compass according to aspects of the disclosure;

FIG. 3 illustrates a block diagram of the power closure member actuation system according to aspects of the disclosure;

FIG. 4 illustrates another block diagram of the power closure member actuation system for moving the closure member in an automatic mode according to aspects of the disclosure;

FIGS. 5 and 5A illustrate the power closure member actuation system shown as part of vehicle system architectures according to aspects of the disclosure;

FIG. 6 illustrates another block diagram of the power closure member actuation system for moving the closure member in a powered assist mode according to aspects of the disclosure;

FIG. 7 illustrates the power closure member actuation system shown as part of the vehicle system architecture corresponding to operation in the powered assist mode according to aspects of the disclosure;

FIG. 8 illustrates a system block diagram of the power closure member actuation system, in accordance with an illustrative embodiment;

FIG. 9 is a superposition algorithm executed by the controller of the of the power closure member actuation system, in accordance with an illustrative embodiment;

FIG. 10 is a partial perspective view of the of actuator of the power closure member actuation system illustrating the torque moments about the door hinge axis corresponding to the superposition algorithm of FIG. 9, in accordance with an illustrative embodiment;

FIG. 11 is a block diagram of the superposition algorithm executed by the controller of the of the power closure member actuation system illustrating the inclusion of torque moments of auxiliary door systems, in accordance with an illustrative embodiment;

FIG. 12 shows a perspective view of the vehicle and shows a positon one of the closure members as angle Theta, in accordance with an illustrative embodiment;

FIG. 13 shows the vehicle in a particular orientation and the resulting steady state gravitational force measured by the at least one closure member accelerometer based on the vehicle pitch/roll orientation, in accordance with an illustrative embodiment;

FIG. 14 shows a plot of variable gravitational force values on the closure member as a function of the position of the closure member, in accordance with an illustrative embodiment;

FIG. 15 shows a top view of the vehicle with closure members and an example position of the at least one closure member accelerometer, in accordance with an illustrative embodiment; and

FIG. 16 illustrates steps of a method of controlling movement of a closure member of a vehicle between open and closed positions relative to a vehicle body using a power closure member actuation system, in accordance with an illustrative embodiment.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a power closure member actuation system or user modifiable system constructed in accordance with the teachings of the present disclosure will now be disclosed. The example embodiment is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

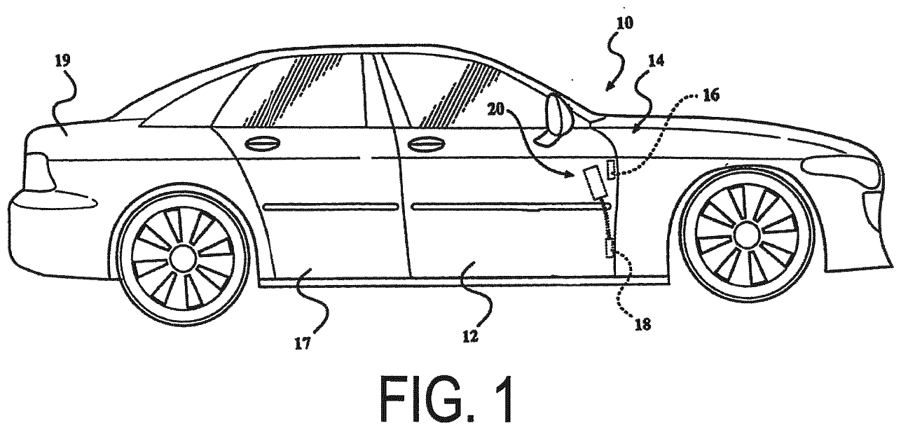

Referring initially to FIG. 1, an example motor vehicle 10 is shown to include a first passenger door 12, or also referred to as an exemplary closure member 12, pivotally mounted to a vehicle body 14 via an upper door hinge 16 and a lower door hinge 18 which are shown in phantom lines. In accordance with the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While power closure member actuation system 20 is only shown in association with front passenger door 12, those skilled in the art will recognize that the power closure member actuation system can also be associated with any other closure member (e.g., door or liftgate) of vehicle 10 such as rear passenger doors 17 and decklid 19.

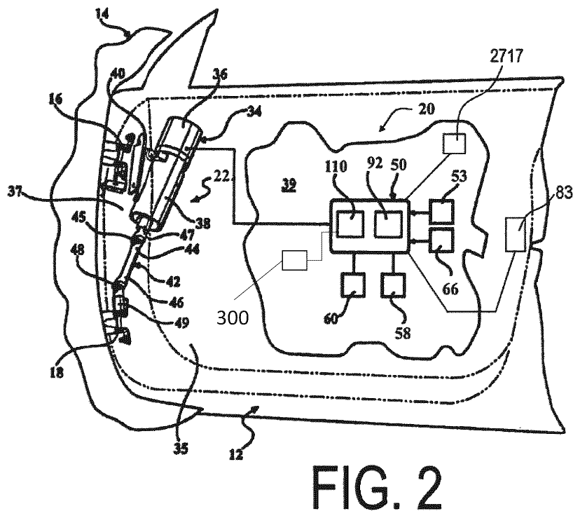

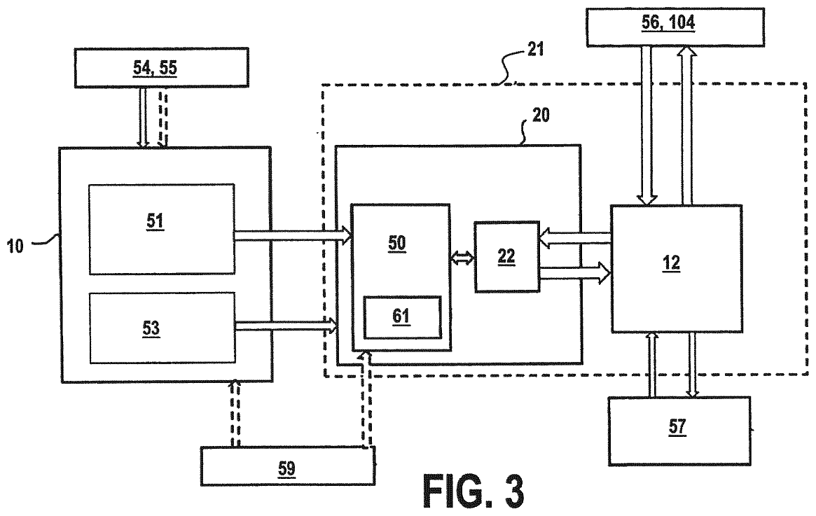

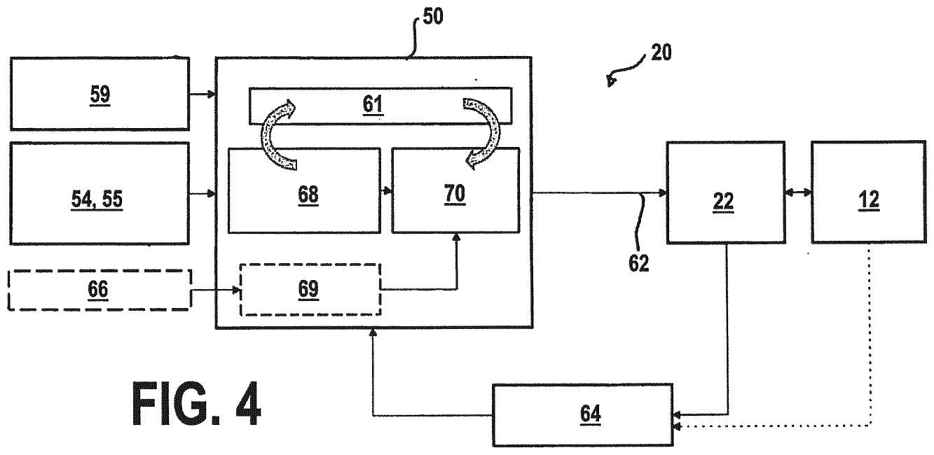

Power closure member actuation system 20 is generally shown in FIG. 2 and, as mentioned, is operable for controllably pivoting vehicle door 12 relative to vehicle body 14 between an open position and a closed position. As shown in FIGS. 4 and 5, lower hinge 18 of power closure member actuation system 20 includes a door hinge strap 28 connected to vehicle door 12 and a body hinge strap 30 connected to vehicle body 14. Door hinge strap 28 and body hinge strap 30 of lower door hinge 18 are interconnected along a generally vertically-aligned pivot axis A via a hinge pin 32 to establish the pivotable interconnection between door hinge strap 28 and body hinge strap 30. However, any other mechanism or device can be used to establish the pivotable interconnection between door hinge strap 28 and body hinge strap 30 without departing from the scope of the subject disclosure.

As best shown in FIG. 2, power closure member actuation system 20 includes a power-operated actuator mechanism 22 having a motor and geartrain assembly 34 that is rigidly connectable to vehicle door 12. Motor and geartrain assembly 34 is configured to generate a rotational force. In the preferred embodiment, motor and geartrain assembly 34 includes an electric motor 36 that is operatively coupled to a speed reducing/torque multiplying assembly, such as a high gear ratio planetary gearbox 38. The high gear ratio planetary gearbox 38 may include multiple stages, thus allowing motor and geartrain assembly 34 to generate a rotational force having a high torque output by way of a very low rotational speed of electric motor 36. However, any other arrangement of motor and geartrain assembly 34 can be used to establish the required rotational force without departing from the scope of the subject disclosure.

Motor and geartrain assembly 34 includes a mounting bracket 40 for establishing the connectable relationship with vehicle door 12. Mounting bracket 40 is configured to be connectable to vehicle door 12 adjacent to the door-mounted door hinge strap associated with upper door hinge 16. As further shown in FIG. 2, this mounting of motor assembly 34 adjacent to upper door hinge 16 of vehicle door 12 disposes the power-operated actuator mechanism 22 of power closure member actuation system 20 in close proximity to the pivot axis A. The mounting of motor and geartrain assembly 34 adjacent to upper door hinge 16 of vehicle door 12 minimizes the effect that power closure member actuation system 20 may have on a mass moment of inertia (i.e., pivot axis A) of vehicle door 12, thus improving or easing movement of vehicle door 12 between its open and closed positions. In addition, as also shown in FIG. 2, the mounting of motor and geartrain assembly 34 adjacent to upper door hinge 16 of vehicle door 12 allows power closure member actuation system 20 to be packaged in front of an A-pillar glass run channel 35 associated with vehicle door 12 and thus avoids any interference with a glass window function of vehicle door 12. Put another way, power closure member actuation system 20 can be packaged in a portion 37 of an internal door cavity 39 within vehicle door 12 that is not being used, and therefore reduces or eliminates impingement on existing hardware/mechanisms within vehicle door 12. Although power closure member actuation system 20 is illustrated as being mounted adjacent to upper door hinge 16 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes a rotary drive mechanism that is rotatively driven by the power-operated actuator mechanism 22. As shown in FIG. 2, the rotary drive mechanism includes a drive shaft 42 interconnected to an output member of gearbox 38 of motor and geartrain assembly 34 and which extends from a first end 44 disposed adjacent gearbox 38 to a second end 46. The rotary output component of motor and geartrain assembly 34 can include a first adapter 47, such as a square female socket or the like, for drivingly interconnecting first end 44 of drive shaft 42 directly to the rotary output of gearbox 38 In addition, although not expressly shown, a disconnect clutch can be disposed between the rotary output of gearbox 38 and first end 44 of drive shaft 42. In one configuration, the clutch would normally be engaged without power (i.e. power-off engagement) and could be selectively energized (i.e. power-on release) to disengage. Put another way, the optional clutch drivingly would couple drive shaft 42 to motor and geartrain assembly 34 without the application of electrical power while the clutch would require the application of electrical power to uncouple drive shaft 42 from driven connection with gearbox 38. As an alternative, the clutch could be configured in a power-on engagement and power-off release arrangement. The clutch may engage and disengage using any suitable type of clutching mechanism such as, for example, a set of sprags, rollers, a wrap-spring, friction plates, or any other suitable mechanism. The clutch is provided to permit door 12 to be manually moved by the user 75 between its open and closed positions relative to vehicle body 14. Such a disconnect clutch could, for example, be located between the output of electric motor 36 and the input to gearbox 38. The location of this optional clutch may be dependent based on, among other things, whether or not gearbox 38 includes “back-driveable” gearing. In one possible configuration, the power-operated actuator mechanism 22 is provided without a clutch mechanism, and so a direct permanent coupling between the motor and output of the power-operated actuator mechanism 22 (e.g. a coupling to the vehicle body 14 for example.) In such a configuration, the geartrain assembly 34 may possibly be a backdriveable geartrain.

Second end 46 of drive shaft 42 is coupled to body hinge strap 30 of lower door hinge 18 for directly transferring the rotational force from motor and geartrain assembly 34 to door 12 via body hinge strap 30. To accommodate angular motion due to swinging movement of door 12 relative to vehicle body 14, the rotary drive mechanism further includes a first universal joint or U-joint 45 disposed between first adapter 47 and first end 44 of drive shaft 42 and a second universal joint or U-joint 48 disposed between a second adapter 49 and second end 46 of drive shaft 42. Alternatively, constant velocity joints could be used in place of the U-joints 45, 48. The second adapter 49 may also be a square female socket or the like configured for rigid attachment to body hinge strap 30 of lower door hinge 18. However, other means of establishing the drive attachment can be used without departing from the scope of the disclosure. Rotation of drive shaft 42 via operation of motor and geartrain assembly 34 functions to actuate lower door hinge 18 by rotating body hinge strap 30 about its pivot axis to which drive shaft 42 is attached and relative to door hinge strap 28. As a result, power closure member actuation system 20 is able to effectuate movement of vehicle door 12 between its open and closed positions by “directly” transferring a rotational force directly to body hinge strap 30 of lower door hinge 18. With motor and geartrain assembly 34 connected to vehicle door 12 adjacent to upper door hinge 16, second end 46 of drive shaft 42 is attached to body hinge strap 30 of lower door hinge 18. Based on available space within door cavity 39, it may be possible to mount motor and geartrain assembly 34 adjacent to the door-mounted hinge component of lower door hinge 18 and directly connect second end 46 of drive shaft 42 to the vehicle-mounted hinge component of upper door hinge 16. In the alternative, if motor and geartrain assembly 34 is connected to vehicle body 14, second end 46 of drive shaft 42 would be attached to door hinge strap 28.

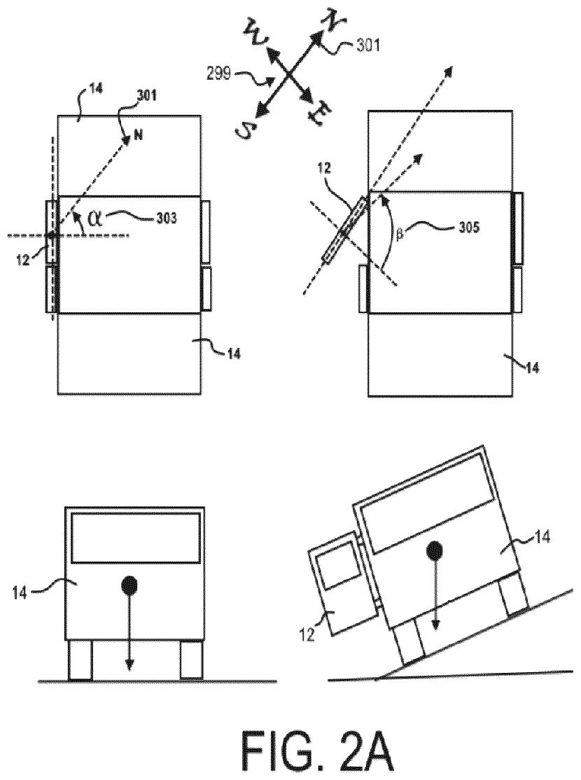

FIG. 3 illustrates a block diagram of the power closure member actuation system 20 of a power door system 21 for moving the closure member (e.g., vehicle door 12) of the vehicle 10 between open and closed positions relative to the vehicle body 14. As discussed above, the power closure member actuation system 20 includes the actuator 22 that is coupled to the closure member (e.g., vehicle door 12) and the vehicle body 14. The actuator 22 is configured to move the closure member 12 relative to the vehicle body 14. The power closure member actuation system 20 also includes a controller 50 that is coupled to the actuator 22 and in communication with other vehicle systems (e.g., a body control module 52) and also receives vehicle power from the vehicle 10 (e.g., from a vehicle battery 53).

The controller 50 is operable in at least one of an automatic mode (in response to an automatic mode initiation input 54) and a powered assist mode (in response to a motion input 56). In the automatic mode, the controller 50 commands movement of the closure member through a predetermined motion profile (e.g., to open the closure member). The powered assist mode is different than the automatic mode in that the motion input 56 from the user 75 may be continuous to move the closure member, as opposed to a singular input by the user 75 in automatic mode. Commands 51 from the vehicle systems may, for example, include instructions the controller 50 to open the closure member, close the closure member, or stop motion of the closure member. Such control inputs, such as inputs 54, 56 may also include other types of inputs 55, such as an input from a body control module, which may receive a wireless command to control the door opening based on a signal such as a wireless signal received from the key fob 60, or other wireless device such as a cellular smart phone, or from a sensor assembly provided on the vehicle, such as a radar or optical sensor assembly detecting an approach of a user, such as a gesture or gait e.g. walk of the user 75 upon approach of the user 75 to the vehicle. Also shown are other components that may have an impact on the operation of the power closure member actuation system 20, such as door seals 57 of the vehicle door 12, for example. In addition, environmental conditions 59 (rain, cold, heat, etc.) may be monitored by the vehicle 10 (e.g., by the body control module 52) and/or the controller 50. The controller 50 also includes an artificial intelligence learning algorithm 61.

Referring now to FIG. 4, the controller 50 is configured to receive the automatic mode initiation input 54 and enter the automatic mode to output a motion command 62 in response to receiving the automatic mode initiation input 54 or input motion command 62. The automatic mode initiation input 54 can be a manual input on the closure member itself or an indirect input to the vehicle (e.g., closure member switch 58 on the closure member, switch on a key fob 60, etc.). So, the automatic mode initiation input 54 may, for example, be a result of a user or operator operating a switch (e.g., the closure member switch 58), making a gesture near the vehicle 10, or possessing a key fob 60 near the vehicle 10, for example. It should also be appreciated that other automatic mode initiation inputs 54 are contemplated, such as, but not limited to a proximity of the user 75 detected by a proximity sensor.

In addition, the power closure member actuation system 20 includes at least one closure member feedback sensor 64 for determining at least one of a position and a speed and an attitude of the closure member. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the controller 50. Feedback sensor 64 in communication with controller 50 is illustrative of part of a feedback system or motion sensing system for detecting motion of the door directly or indirectly, such as by detecting changes in speed and position of the closure member, or components coupled thereto. For example, the motion sensing system may be hardware based (e.g. a hall sensor unit an related circuitry) for detecting movement of a target on the closure member (e.g. on the hinge) or actuator 22 (e.g. on a motor shaft) as examples, and/or may also be software based (e.g. using code and logic for executing a ripple counting algorithm) executed by the controller 50 for example. Other types of position, speed, and/or orientation detectors such as accelerometers and induction based sensors may be employed without limitation.

The power closure member actuation system 20 additionally includes at least one non-contact obstacle detection sensor 66 which may form part of a non-contact obstacle detection system coupled, such as electrically coupled, to the controller 50. The controller 50 is configured to determine whether an obstacle is detected using the at least one non-contact obstacle detection sensor 66 (e.g., using a non-contact obstacle detection algorithm 69) and may, for example, cease movement of the closure member in response to determining that the obstacle is detected. The non-contact obstacle detection system may also be configured to calculate distance from the closure member to the object or obstacle, or to a user as the object or obstacle, to the door 12. For example non-contact obstacle detection system may be configured to perform time of flight calculations to determine distance using a radar based sensor 66 or to characterize the object as a user or human as compared to an non-human object for example based on determining the reflectivity of the object using a radar based sensor 66 and system. The non-contact obstacle detection system may also be configured determine when an obstacle is detected, for example by detecting reflected waves of the object or obstacle or user of radar transmitted from the obstacle sensor 66. The non-contact obstacle detection system may also be configured determine when an obstacle is not detected, for example by not detecting reflected waves of the object or obstacle or user of radar transmitted from the obstacle sensor 66. The operation and example of the at least one non-contact obstacle detection sensor 66 and system are discussed in U.S. Patent Application No. 2018/0238099, incorporated herein by reference.

In the automatic mode, the controller 50 can include one or more closure member motion profiles 68 that are utilized by the controller 50 when generating the motion command 62 (e.g., using a motion command generator 70 of the controller 50) in view of the obstacle detection by the at least one non-contact obstacle detection sensor 66. So, in the automatic mode, the motion command 62 has a specified motion profile 68 (e.g., acceleration curve, velocity curve, deceleration curve, and finally stops at an open position) and is continually optimized per user feedback (e.g., automatic mode initiation input 54).

In FIG. 5, the power closure member actuation system 20 is shown as part of a vehicle system architecture 72 corresponding to operation in the automatic mode. The power closure member actuation system 20 includes a user interface 74, 76 that is configured to detect a user interface input from a user 75 via an interface 77 (e.g., touchscreen) to modify at least one stored motion control parameter associated with the movement of the closure member. Thus, the controller 50 of the power closure member actuation system 20 or user modifiable system is configured to present the at least one stored motion control parameter on the user interface 74, 76.

The body control module 52 is in communication with the controller 50 via a vehicle bus 78 (e.g., a Local Interconnect Network or LIN bus). The body control module 52 can also be in communication with the key fob 60 (e.g., wirelessly) and a closure member switch 58 configured to output a closure member trigger signal through the body control module 52. Alternatively, the closure member switch 58 could be connected directly to the controller 50 or otherwise communicated to the controller 50. The body control module 52 may also be in communication with an environmental sensor (e.g., temperature sensor 80). The controller 50 is also configured to modify the at least one stored motion control parameter in response to detecting the user interface input. A screen communications interface control unit 82 associated with the user interface 74, 76 can, for example, communicate with a closure communications interface control unit 84 associated with the controller 50 via the vehicle bus 78. In other words, the closure communication interface control unit 84 is coupled to the vehicle bus 78 and to the controller 50 to facilitate communication between the controller 50 and the vehicle bus 78. Thus, the user interface input can be communicated from the user interface 74, 76 to the controller 50.

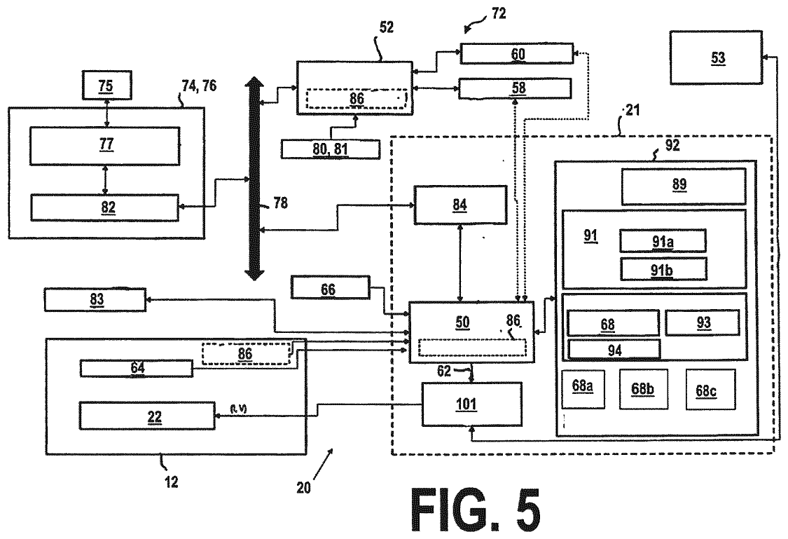

A vehicle inclination sensor 86 (such as an accelerometer) is also coupled to the controller 50 for detecting an inclination of the vehicle 10. The vehicle inclination sensor 86 outputs an inclination signal corresponding to the inclination of the vehicle 10 and the controller 50 is further configured to receive the inclination signal and adjust the one of a force command 88 (FIG. 6) and the motion command 62 accordingly. While the vehicle inclination sensor 86 may be separate from the controller 50, it should be understood that the vehicle inclination sensor 86 may also be integrated in the controller 50 or in another control module, such as, but not limited to the body control module 52.

The controller 50 is further configured to perform at least one of an initial boundary condition check prior to the generation of the command signal (e.g., the force command 88 or the motion command 62) and an in-process boundary check during the generation of the command signal. Such boundary checks prevent movement of the closure member and operation of the actuator 22 outside a plurality of predetermined operating limits or boundary conditions 91 and will be discussed in more detail below.

The controller 50 can also be coupled to a vehicle latch 83. In addition, the controller 50 is coupled to a memory device 92 having at least one memory location for storing at least one stored motion control parameter associated with controlling the movement of the closure member (e.g., door 12). The memory device 92 can also store one or more closure member motion profiles 68 (e.g., movement profile A 68a, movement profile B 68b, movement profile C 68c) and boundary conditions 91 (e.g., the plurality of predetermined operating limits such as minimum limits 91a, and maximum limits 91b). The memory device 92 also stores original equipment manufacturer (OEM) modifiable door motion parameters 89 (e.g., door check profiles and pop-out profiles).

The controller 50 is configured to generate the motion command 62 using the at least one stored motion control parameter to control an actuator output force acting on the closure member to move the closure member. A pulse width modulation unit 101 is coupled to the controller 50 and is configured to receive a pulse width control signal and output an actuator command signal corresponding to the pulse width control signal.

Similar to FIG. 5, FIG. 5A shows the power closure member actuation system 20 as part of another vehicle system architecture 72′ operable in the automatic mode and the powered assist mode. The body control module 52 may also be in communication with at least one environmental sensor 80, 81 for sensing at least one environmental condition 59. Specifically, the at least one environmental sensor 80, 81 can be at least one of a temperature sensor 80 or a rain sensor 81. While the temperature sensor 80 and rain sensor 81 may be connected to the body control module 52, they may alternatively be integrated in the body control module 52 and/or integrated in another unit such as, but not limited to the controller 50. In addition, other environmental sensors 80, 81 are contemplated.

The controller is also coupled with the latch 83 that includes a cinch motor 99 (for cinching the closure member 12 into the closed position). The latch 83 also includes a plurality of primary and secondary ratchet position sensors or switches 85 that provide feedback to the controller 50 regarding whether the latch 83 is in a latch primary position or a latch secondary position, for example.

Again, the vehicle inclination sensor 86 (such as an accelerometer or inclinometer) is also coupled to the controller 50 for detecting the inclination of the vehicle 10. The vehicle inclination sensor 86 outputs an inclination signal corresponding to the inclination of the vehicle 10 and the controller 50 is further configured to receive the inclination signal and adjust the one of the force command 88 (FIG. 6) and the motion command 62 accordingly. Accordingly may be for example adjusting the motion command 62 such that door 12 moves at the same speed and motion profile as compared to the door 12 being moved by a motion command as if on a level terrain. As a result, the actuator 22 may move the door 12 such that the motion profile (e.g. speed versus door position) when on an incline is the same as or is tracking to the motion profile as if the vehicle was not on an incline. In other words the user detects no visual difference in the door motion appearance of speed versus position as when the vehicle 10 is on an incline or not. Or for example accordingly may be adjusting the force command 88 such that door 12 is moved applying the similar resistance force detected by a user as compared to the door being moved by a force command as if on level terrain. As a result, the actuator 22 may move the door such that the force required to move the door 12 by a user when on an incline is the same as the force required by a user to move the door as if the vehicle was not on an incline. In other words, the user experiences the same reactionary resistive force of the door acting against the input force of the user when the vehicle 10 is on an incline or not.

A pulse width modulation unit 101 is also coupled to the controller 50 and is configured to receive a pulse width control signal and output an actuator command signal corresponding to the pulse width control signal. The controller 50 includes a processor or other computing unit 110 in communication with the memory device 92. So, the controller 50 is coupled to the memory device 92 for storing a plurality of automatic closure member motion parameters 68, 93, 94, 95 for the automatic mode and a plurality of powered closure member motion parameters 96, 100, 102, 106 for the powered assist mode and used by the controller 50 for controlling the movement of the closure member (e.g., door 12 or 17). Specifically, the plurality of automatic closure member motion parameters 68, 93, 94, 95 includes at least one of closure member motion profiles 68 (e.g., plurality of closure member velocity and acceleration profiles), a plurality of closure member stop positions 93, a closure member check sensitivity 94, and a plurality of closure member check profiles 95. The plurality of powered closure member motion parameters 96, 100, 102, 106 includes at least one of a plurality of fixed closure member model parameters 96 and a force command generator algorithm 100 and a closure member model 102 and a plurality of closure member component profiles 106. In addition, the memory device 92 stores a date and mileage and cycle count 97. The memory device 92 may also store boundary conditions (e.g., plurality of predetermined operating limits) used for a boundary check to prevent movement of the closure member and operation of the actuator 22 outside a plurality of predetermined operating limits or boundary conditions.

A compass 300 may be connected to the computing unit 110. The compass 300 may be formed as microchip device such as for example Honeywell's 3-Axis Digital Compass HMC5843, and provided as part of the computing unit 100 in one possible configuration. Otherwise, compass 300 may be mounted at other positions on the door 12. For example, the compass 300 may be mounted on the same printed circuit board as the other electronics forming the computing unit 110. Compass 300 is thus configured to detect the change in orientation of the door 12 relative to a magnetic field, and in particular relative to the magnetic North direction. With reference to FIG. 2A, when door 12 is in a closed position, the computing unit 110 determines the door is in the closed position and register the door angle relative to the magnetic north direction 301 as detected by the compass 300. Magnetic North 301 is shown as part of the compass rose 299. When door 12 is moved to an open position, the computing unit 110 determines the door angle relative to the vehicle body 14 by calculating the change in the compass direction outputted by compass 300 when the door 12 is in the open position (angle Alpha 303) compared to when the door 12 is in the door closed position (angle Beta 305). Compass 300 direction is read by the computing unit 110 when the door is in the door closed position. Compass 300 direction may be read by the computing unit 110 for example after the vehicle has been detected to be in a stationary position prior to changing orientation, such as by detecting when the vehicle has been shifted into Park (P.) when the door is in the door closed position In known power system door system, use of hall counts located in a power door actuator is employed as a means to determine the position of the door. Using a position device such as compass 300 provides a manner to determine the door position that is independent of an absolute position device associated with the powered actuator and a manner to determine door position in the event of power loss while the door is open which causes the power systems loose the detected position of the door angle using the absolute position device. As a result, hall sensors provided in the actuator or on the door hinge for example are not required, and there is no need to store a position of the door angle in the system memory. Eliminating sensors in the drive unit can provide for a reduction in size of the actuator and the elimination of wiring running into and out of the drive unit 22. When compass is describes with reference to detecting a magnetic field to determine a constant reference point of the earth, other compass device types may also be employed not relying on magnetic fields, such as a gyrocompass, to determine a position of the door. Still other types of inertia based devices may be employed to determine position of the door without used of external reference inputs. Consequently, the controller 50 is configured to receive one of the motion input 56 associated with the powered assist mode and the automatic mode initiation input 54 associated with the automatic mode. The controller 50 is then configured to send the actuator 22 one of a motion command 62 based on the plurality of automatic closure member motion parameters 68, 93, 94, 95 in the automatic mode and the force command 88 based on the plurality of powered closure member motion parameters 96, 100, 102, 106 in the powered assist mode to vary the actuator output force acting on the closure member 12 to move the closure member 12. The controller 50 additionally monitors and analyzes historical operation of the power closure member actuation system 20 using the artificial intelligence learning algorithm 61 and adjusts the plurality of automatic closure member motion parameters 68, 93, 94, 95 and the plurality of powered closure member motion parameters 96, 100, 102, 106 accordingly.

As discussed above, the power closure member actuation system 20 can include an environmental sensor 80, 81 in communication with the controller 50 and configured to sense at least one environmental condition of the vehicle 10. Thus, the historical operation monitored and analyzed by the controller 50 using the artificial intelligence learning algorithm 61 can include the at least one environmental condition of the vehicle 10. So, the controller is further configured to adjust the plurality of automatic closure member motion parameters 68, 93, 94, 95 and the plurality of powered closure member motion parameters 96, 100, 102, 106 based on the at least one environmental condition of the vehicle 10.

As best shown in FIG. 6, the controller 50 is also configured to receive the motion input 56 and enter the powered assist mode to output the force command 88 (e.g., using a force command generator 98 of the controller 50 as a function of a force command algorithm 100, door model 102, boundary conditions 91, a plurality of closure member component profiles 106 as discussed in more detail below) as modified by the artificial intelligence learning algorithm 61. The controller 50 is also configured to generate the force command 88 to control an actuator output force acting on the closure member to move the closure member. So, the controller 50 varies an actuator output force acting on the closure member to move the closure member in response to receiving the motion input 56. In the powered assist mode, the force command 88 has a specified force profile (e.g., that may be altered to change the user experience with the closure member, such as by making it lighter or heavier, or based on changes in the environmental condition and modified by the artificial intelligence learning algorithm 61, such as by increasing or decreasing the force assist provided to the user 75). The force command 88 is continually optimized per current user feedback, for example. A user movement sensor 104 is coupled to the controller 50 and is configured to sense the motion input 56 from the user 75 on the closure member to move the closure member. Door motion feedback 105 is also provided from the closure member (e.g., door 12) back to the user 75. Again, the power closure member actuation system 20 further includes at least one closure member feedback sensor 64 for determining at least one of a position and speed of the closure member. The at least one closure member feedback sensor 64 detects the position and/or speed of the closure member, as described above for the automatic mode, and can provide corresponding position/motion information or signals to the controller 50 concerning how the user 75 is interacting with the closure member. For example, the at least one closure member feedback sensor 64 determine how fast the user 75 is moving the closure member (e.g., door 12). The attitude or inclination sensor 86 may also determine the angle or inclination of the closure member and the power closure member actuation system 20 may compensate for such an angle to assist the user 75 and negate any effects on the closure member motion that the change in angle causes (e.g., for example changes regarding how gravity may influence the closure member differently based on the angle of the closure member relative to a ground plane).

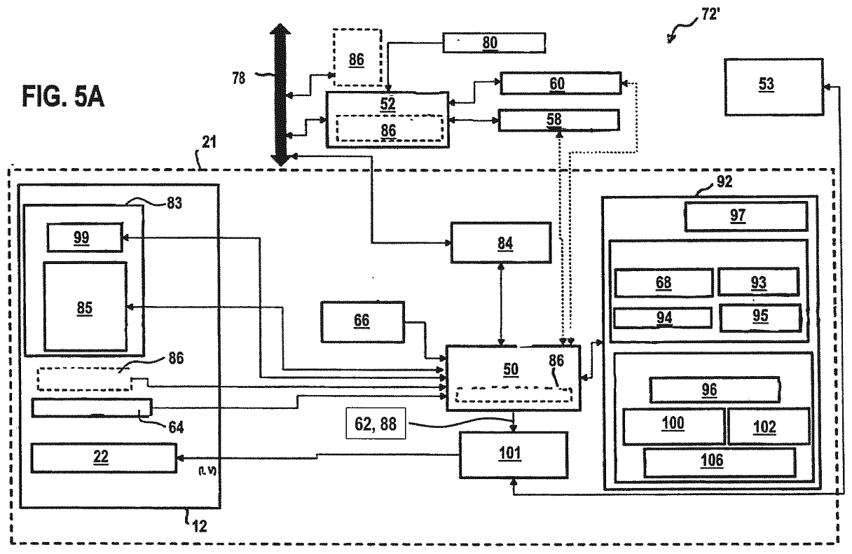

Like the vehicle system architecture shown in FIG. 5, a vehicle system architecture 72″ corresponding with operation of the power closure member actuation system 20 of FIG. 6 in the powered assist mode is shown in FIG. 7. Again, the power closure member actuation system 20 includes the user interface 74, 76 that is configured to detect a user interface input to modify at least one stored motion control parameter associated with the movement of the closure member. The controller 50 of the power closure member actuation system 20 or user modifiable system is configured to present the at least one stored motion control parameter on the user interface 74, 76 (e.g., displayed parameters and functions 111). The controller 50 is also configured to modify the at least one stored motion control parameter stored in the memory device 92 in response to detecting the user interface input. So, the memory device 92 stores the at least one stored motion control parameter and other closure member parameters 106 used by the system 20 for assisting the user 75 with moving the closure member, such as weight 106a, and dimensions of the closure member 106b, closure member inertia 106c, closure member friction 106d, other closure member attributes 106e any mathematical models of the closure member (e.g., closure member model 102), any models of physical components 108 (e.g., door seal model 108a, actuator time/wear/temperature based model 108b) influencing the closure member motion that may vary over time due to wear, for example, and door functions 109 (e.g., anti-pinch, door check).

Consequently, the controller 50 is configured to generate the force command 88 based on the at least one stored motion control parameter and the at least one environmental condition 59 to control the actuator output force acting on the closure member to move the closure member. Again, the closure communications interface control unit 84 is coupled to a vehicle bus 78 and to the controller 50 to facilitate communication between the controller 50 and the vehicle bus 78. The pulse width modulation unit 101 is coupled to the controller 50 and is configured to receive the pulse width control signal and output the actuator command signal corresponding to the pulse width control signal. As in FIG. 5, the closure communications interface control unit 84 is coupled to the vehicle bus 78 and to the controller 50 to facilitate communication between the controller 50 and the vehicle bus 78.

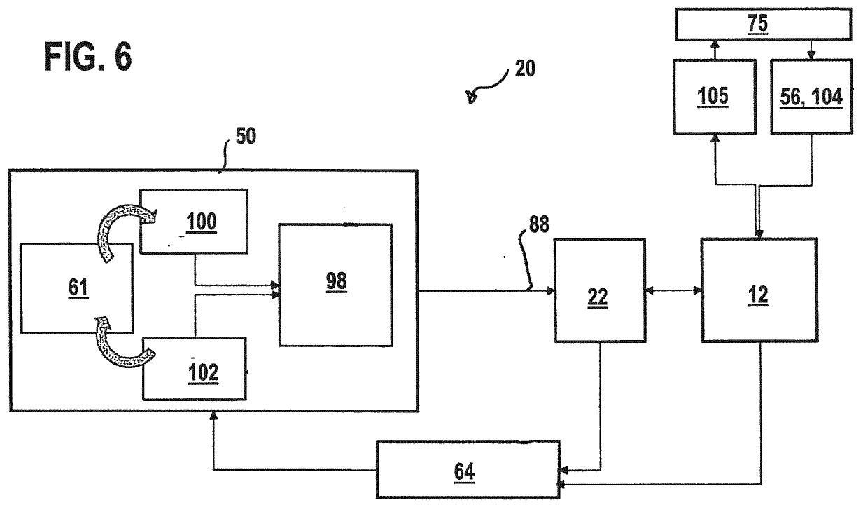

Now referring to FIG. 8, in accordance with another exemplifying configuration of the power closure member actuation system 20, 2700, the controller 50, 2702 is configured to receive one of the motion input 56, 2704 associated with the power closure member actuation system 20, 2700 operating in the power assist mode. The controller 50, 2702 is then configured to send the actuator 22, 2705 the force command 88, 2706 based on at least one calculated torque moment 2705 based on torque models 2708 stored in memory of the controller 50, 2702, in the powered assist mode to vary the actuator 22, 2705 output force acting on the closure member 12, 2710 to move the closure member 12, 2710. In addition, the power closure member actuation system 20, 2700 includes at least one closure member feedback sensor 64, 2712 for determining at least one of a position and a speed and an attitude of the closure member 12, 2710. Thus, the at least one closure member feedback sensor 64, 2712 detects signals from either the actuator 22, 2705 by counting revolutions of the electric motor 36, 2714, absolute position of an extensible member (not shown), or from the door 12, 2710 (e.g., an absolute position sensor on a door hinge as an example) to provide position information to the controller 50, 2702. Other types of feedback systems may be provided for sensing the position of the door 12. The controller 50, 2702 is also configured to receive the motion input 56, 2704 and enter the powered assist mode to output the force command 88, 2706 (e.g., using a force command generator 98, 2716 of the controller 50, 2702 as a function of a force command algorithm 100, for example configured as the superposition algorithm 2718 stored in memory as described herein above. The superposition algorithm 2718 is configured to receive the output of the torque calculator 2720 configured to determine the net torque response about door pivot axis 2650 using the torque models 2708 also stored in memory which are updated in real time based on receiving signals representative of the position and speed of the closure member 12, 2710 for feedback sensors 64, 2712, and also possibly from other sensors 2713 such as environmental sensors 80, 81 for example, as well as other parameters relating to the current state of the closure member 12, 2710. The superposition algorithm 2718 will output the compensating net torque response and the controller 50, 2702 is configured to generate the force command 88, 2706 based on the calculated net torque response to control an actuator output force acting on the closure member 12, 2710 to move the closure member while providing a change in the resistance experienced by a user moving the door compared to a normal non-powered controlled door. Therefore, there is provided a powered closure member actuation system 20 having a controller 50 operable in the power assist mode, the controller 50 being in communication with an actuator 22, where the controller 50 is configured to control the actuator 22 to inconsistently vary a resistance detectable at the door during the motion of the door. In another possible configuration, the inconsistently variation in the resistance detectable at the door, such as by a user or a force sensor, replicates the inconsistent variation in the resistance detectable at the door when the door motion is not being controlled by the actuator 22.

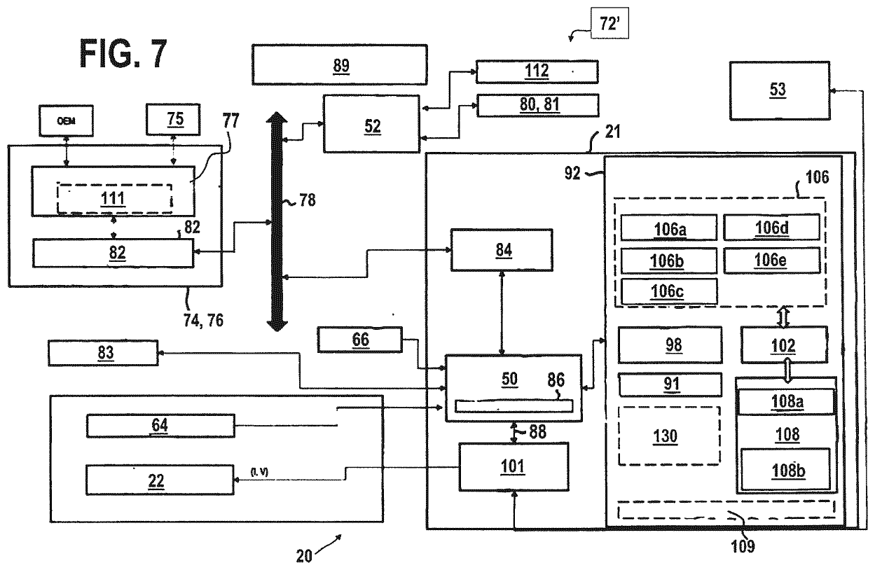

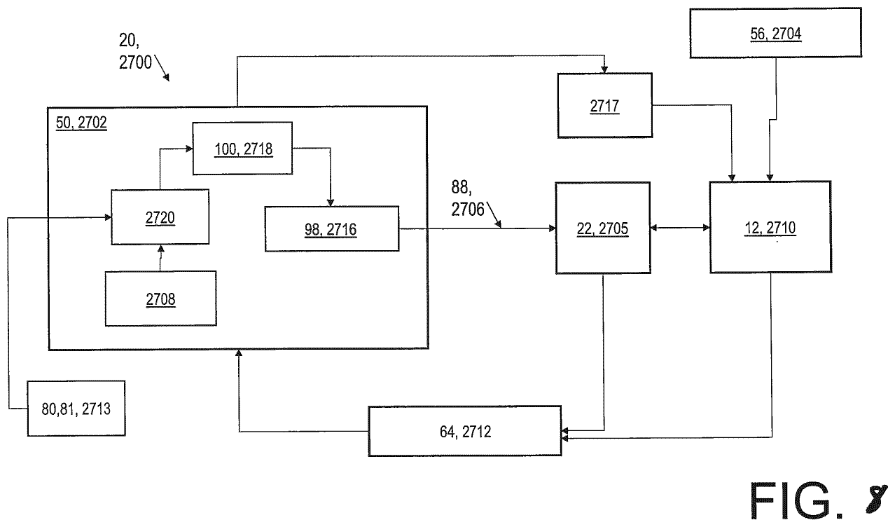

Now referring to FIGS. 9 and 10, there is illustrated an example of a superposition algorithm (FIG. 9) executed by the controller 50 using at least one relevant torque moment 2705. For example shown in FIG. 9 are the relevant torque moments 2705a relating to inclination, or hinge bias, as examples acting about the door pivot axis 2560 which may illustratively act to cause the door 12 to swing open as shown (clockwise direction) in FIG. 10 as arrow 2800; the relevant torque moment 2705b relating to the inertia of the door which initially acts against the door from moving towards the open position, but acts to continue to urge the door towards the open position as the velocity of the door increases shown in FIG. 10 as arrow 2802, a relevant torque moment 2705c relating to friction which acts to resist the door opening towards the opening position shown in FIG. 10 as arrow 2804 shown counterclockwise about axis 2650, a relevant torque moment 2705d relating to detent positions of the door hinge or a door check if the vehicle is configured with such detents tending to resist the door from moving towards the open position at only a predetermined angular position of the door, for example as shown in FIG. 10 as arrow 2806. Other relevant torque moments 2705, such as a damping torque moment 2705e, for example as imparted by a dampening strut or device or the like which may affect the door motion may be included in the superposition calculation. The superposition algorithm 2718 may calculate the compensating net torque response 2707 to negate the sum of the individual relevant torque moments as would be provided by the torque moment of the actuator 22 and the controller 50 is configured to generate the force command 88 based on the calculated net torque response to control the actuator output force acting on the closure member to generate the compensating net torque response 2707 and as a result move the closure member to either control a resistance experienced by the user when moving the door in power assist or control an assistance experienced by the user when moving the powered door, as represented by arrow 2808 in FIG. 10. Arrow 2808 is shown as being clockwise in direction to provide an assistance with moving the door towards the open position, but may be counterclockwise to provide resistance to door motion towards the open position. The compensating net torque response 2707 may be variable over the angular change of the door to provide a consistent door feel to the user over the entire motion of the door 12 regardless of the door weight, the speed of motion of the door, gravitational effects, and the like which may vary over the angular change of the door 12. In another possible configuration, the compensating net torque response 2707 may be variable over the angular change of the door to provide an in-consistent door feel to the user over the entire motion of the door 12 to introduce changes in resistance or assistance for sensing by the user over the angular change of the door 12. For example, such inconsistencies may provide sensations to the user by increasing in forces around simulated detent positions. As another example, the controller 50, 2702 may provide inconsistencies in resistance and assistance so that a user experiences the same forces during moving the door in manual mode but with such forces being scaled to provide the user with a familiar door opening experience such as would be with moving a manual un-powered door, but with the forces reduced as sensed by the user. For example, the controller 50, 2702 may be configured to vary the resistance such that the user still experiences a force associated with overcoming the inertia of the door when at rest, or for example the controller 50, 2702 may be configured to vary the resistance such that the user still experiences a force associated with the continued inertia of the door when at motion, of for example the controller 50, 2702 may be configured to vary the assistance such that the user still experiences a force associated with overcoming the effect of gravity when the door is being moved and the vehicle 10 is at an inclination such that the door does not feel as if it is on level surface. Such a purposeful introduction of inconsistencies in door resistance and assistance is provided to mimic the forces normally associated with an unpowered door that the user is familiar with to provide a varying degree of haptic feedback to the user as compared to a powered assistance that is consistent throughout the door motion which users may not be familiar with as compared to when moving an unpowered door. During door motion, the compensating net torque response 2707 may be positive to provide an assisting force to the door and also be negative to provide a resistive force to the door, such that the user during the manual interaction of the door will experience the same, or the scaled, force over the entire door's motion. In some instances, the controller 50 may calculate the compensating net torque response 2707, for example by applying an internal scaling variable, such that the resistive force experienced by the user is reduced to almost zero for providing a weightless door sensation, and in other configurations, the controller 50 may calculate the compensating net torque response 2707 such that the resistive force experienced by the user is increased for providing a heavier door sensation to the user. In this illustrative example the clockwise torque about the axis 2650 caused by the actuator 22 will act to move the door while also reducing the resistance experienced by the user acting on the door, or in other words the required opening torque moment 2709 the user has to input to move the door 12 about the axis 2650. Therefore, depending on the desired experience of the user, the control of the actuator can cause the user to experience wither a heavier door (more resistance felt by the user when moving the door) or a lighter door (less resistance felt by the user when moving the door), and one that simulates a normal unpowered door motion but with scaling forces sensed by the user moving the door. The sensed forces by the user can be measured using a force sensor as discussed herein above. FIG. 10 illustrates actuator 22 as a rack and pinion type actuator with an extendable rack, as but one type of actuator 22 which may be employed in the power closure member actuation systems 20 described herein. In one possible configuration, the actuators 22 described herein are not provided with a clutch, and in otherwise have a continuously engaged drive (e.g. always coupled) connection between the motor 2711 and the mounting bracket 2713 on the vehicle body 14. Therefore in both the power assist mode and the automatic mode, the controller 50 may in one possible configuration control the door as a function of the position of the door in real time in order to determine the force command 88 or the motion command 62. While the user when moving the door in power assist mode may have a quasi-manual control of the door, the power closure member actuation system 20 may limit the speed of the door at which the user may move the door when operating in power assist mode, for example the controller 50 may limit or cap the speed of the door to a maximum of 60 degrees per second, and may transition to the anti-slam mode above this speed as described herein above.

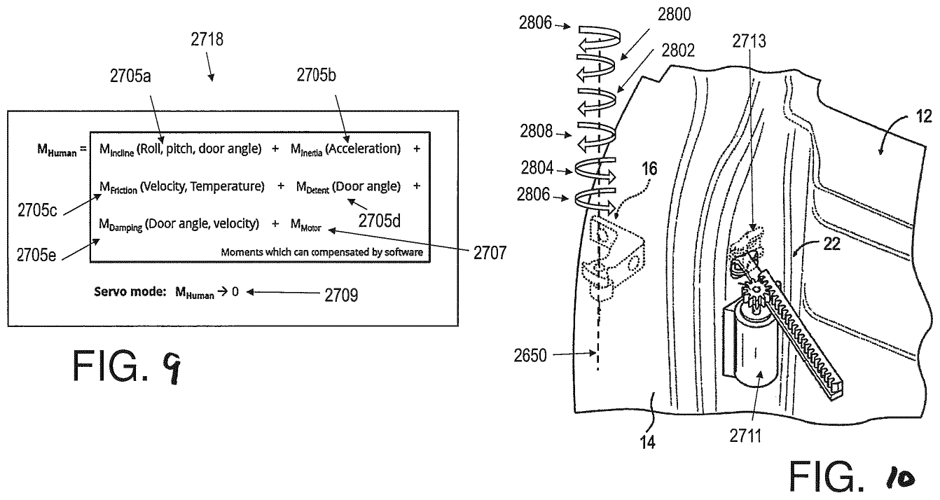

Now referring to FIG. 11, there is illustrated an example of the controller 50, 2702 determining if any auxiliary door systems are active and updating the relevant torque moments to include a relevant torque moments related to an auxiliary door system, such as a door presenter 2717 for the door angles which the door presenter 2717 will be activated, for example to assist with an ice breaking function as described herein above. For example, the controller 50, 2702 may determine if a door presenter is activated to also assist with moving the door, and include the relevant torque moment(s) 2902 of the auxiliary system(s) acting about the axis 2650 updated in real time based on the door angle for inclusion as part of the superposition calculation function 2718. Such auxiliary door systems may be selectively activated for acting on the door for a portion of the door angle as shown by arrow 2808 in FIG. 10. Other door systems having a related relevant torque moments 2904 may be included or removed by the controller 50 when performing the superposition function 2718, such as if a separate door check mechanism is acting on the door, if a separate brake mechanism is acting on the door, if another door is interacting with the door such as in the case of a B-pillarless door system, as examples and without limitation. Therefore, the controller 50, 2702 may execute a summation 2906 of the net torque response 2908 as illustratively determined in method step 2612 described herein above, which with reference to FIG. 9 includes illustratively the summation of torque moments 2705a to 2705d, the compensating torque 2910, as illustratively determined in method step 2616 and illustratively the torque moment of the actuator 22 about the axis 2650 described herein above, and proceed to calculate a force command 2912 using the force command generator 2914 to be supplied to the motor 2916. Any inclusion or exclusion of the relevant torque moment(s), such as torque moment(s) 2902 if door presenter 2717 is influencing the door movement can be added or removed without effecting the normal (without auxiliary door systems influencing door motion) power assist compensation calculations when such other relevant torque moment(s) due to the auxiliary system(s) is not being activated (for example based on door angle), or not being available (for example not being installed on the vehicle, or disabled due to damage). As a result the power closure member actuation system 20 can support the expansion of additional door motion influencing functions during door motion such as functions only operable during certain ranges of motion of the door or states of the door, or support the modularity of different configurations of the power closure member actuation system 20 such as the installation of additional mechanisms such as a mechanical door check, dampeners such as counterbalancing struts, an electromechanical brake mechanism, and so forth without limitation.

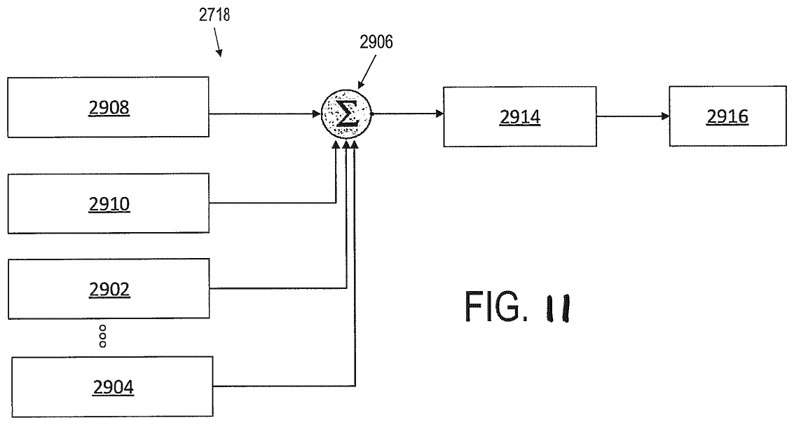

FIG. 12 shows a perspective view of the vehicle 10 and shows a positon one of the closure members 12, 17, 19, 2710 (door 12) as angle Theta (8). As mentioned above, when moving the closure member 12, 17, 19, 2710 using the actuator 22, 2705, the power closure member actuation system 20, 2700 may take into account the inclination or orientation of the vehicle 10 determined by the vehicle inclination sensor 86 and adjust the force command 88 and/or the motion command 62 accordingly. However, there is software inefficiency (processing time. data lag) when the accelerometer data or inclination signal from the accelerometer 86 needs to be monitored continuously for changes in gravitational force over travel of the closure member 12, 17, 19, 2710 from open to close. The requirement for continuous monitoring also creates a failure mode for data inaccuracy. Furthermore, there is a cost impact to requiring an accelerometer on each closure member 12, 17, 19, 2710 (e.g., four or five accelerometers 86 on a four door vehicle).

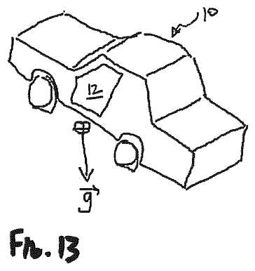

Thus, according to an aspect, another power closure member actuation system 20, 2700 for moving the closure member 12, 17, 19, 2710 of the vehicle 10 between the open position and the closed position relative to the vehicle body 14 is provided. As above, the power closure member actuation system 20, 2700 includes an actuator 22, 2705 coupled to the closure member 12, 17, 19, 2710 and the vehicle body 14 configured to move the closure member 12, 17, 19, 2710 relative to the vehicle body 14. In addition, the power closure member actuation system 20, 2700 includes at least one closure member accelerometer (e.g., vehicle inclination sensor 86 of FIG. 5A) configured to determine a steady state gravitational force on the closure member 12, 17, 19, 2710 according to an orientation of the vehicle 10. FIG. 13 shows the vehicle 10 in a particular orientation and the resulting steady state gravitational force (gravitational vector g) measured by the at least one closure member accelerometer 86 based on the vehicle pitch/roll orientation. The power closure member actuation system 20, 2700 additionally includes a controller 50, 2702 in communication with the at least one closure member accelerometer 86 and the actuator 22, 2705. The controller 50, 2702 is configured to determine the steady state gravitational force on the closure member 12, 17, 19, 2710 while the closure member 12, 17, 19, 2710 is in a predetermined position and is not moving. The controller 50, 2702 controls movement of the closure member 12, 17, 19, 2710 by the actuator 22, 2705 to compensate for variable gravitational forces on the closure member 12, 17, 19, 2710 during movement of the closure member 12, 17, 19, 2710. The variable gravitational forces used to control the movement are predetermined and selected according to a position of the closure member 12, 17, 19, 2710 and the steady state gravitational force. According an aspect, the controller 50, 2702 is configured to determine the steady state gravitational force on the closure member 12, 17, 19, 2710 temporally before the closure member 12, 17, 19, 2710 is moved by the actuator 22, 2705. According to another aspect, the predetermined position is the closed position of the closure member 12, 17, 19, 2710.

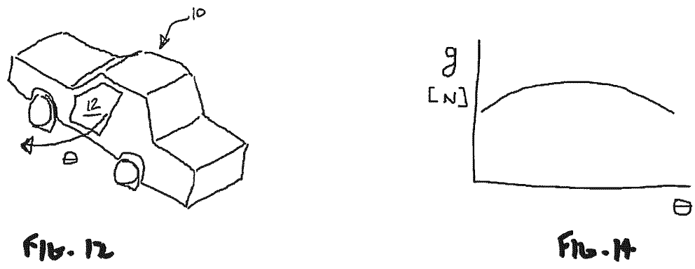

As discussed above, the power closure member actuation system 20, 2700 may also include a closure member feedback sensor 64, 2712 configured to determine at least one of the position and a speed of the closure member 12, 17, 19, 2710. The position of the closure member 12, 17, 19, 2710 can include a plurality of positions of the closure member 12, 17, 19, 2710 between the closed position and the open position. Additionally, the variable gravitational forces used to control the movement may include a plurality of variable gravitational force values for each of the plurality of positions of the closure member 12, 17, 19, 2710 between the closed position and the open position. FIG. 14 shows a plot of variable gravitational force values on the closure member 12, 17, 19, 2710 as a function of the position of the closure member 12, 17, 19, 2710. So, according to an additional aspect, the plurality of variable gravitational force values can be predetermined through mathematical modelling prior to the controller 50, 2702 being installed in the vehicle 10. In more detail, the position of the closure member 12, 17, 19, 2710 relative to gravity may, for example, be modelled in computer assisted design (CAD) based on kinematics. More specifically, left and right door motions are opposite vectors and front and rear doors can be modelled independently.

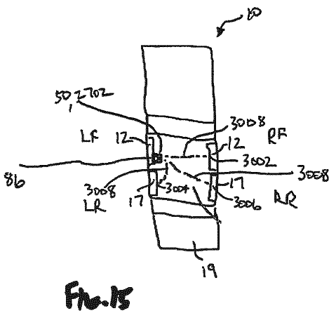

FIG. 15 shows a top view of the vehicle 10 with closure members 12, 17, 19, 2710 and an example position of the at least one closure member accelerometer 86. As shown and according to a further aspect of the disclosure, the at least one closure member accelerometer 86 includes a single closure member accelerometer 86 disposed on the vehicle 10 and coupled to the controller 50, 2702. The vehicle 10 can include a plurality of other closure members 12, 17, 19, 2710 separate from the closure member 12, 17, 19, 2710 and each movable relative to the vehicle body 14 using one of a plurality of other actuators 22, 2705 in communication with and controlled by the controller 50, 2702. For example, the vehicle 10 can be a two door vehicle and the closure member 12, 17, 19, 2710 may be the driver's side front door 12 and the plurality of other closure members 12, 17, 19, 2710 may include the passenger side front door 12 and a decklid 19 or lift gate. In another example, the vehicle 10 may be a four door vehicle and the closure member 12, 17, 19, 2710 may be driver's side front door 12, while the plurality of other closure members 12, 17, 19, 2710 can include driver's side rear door 17, the passenger side front door 12, the passenger's side rear door 17, and a decklid 19 or lift gate. Thus, according to an aspect, the controller 50, 2702 is configured to control movement of each of the plurality of other closure members 12, 17, 19, 2710 to compensate for the variable gravitational forces on each of the plurality of other closure members 12, 17, 19, 2710 during movement of the each of the plurality of other closure members 12, 17, 19, 2710. The variable gravitational forces used to control the movement are predetermined and selected according to the position of each of the plurality of other closure members 12, 17, 19, 2710 and the steady state gravitational force from the single closure member accelerometer 86. In other words, each of the plurality of other closure members 12, 17, 19, 2710 may not include their own closure member accelerometer 86, only one is needed for the vehicle 10. According to another aspect, the single closure member accelerometer 86 is disposed on the closure member 12, 17, 19, 2710 remotely from the plurality of other closure members 12, 17, 19, 2710.

Similarly, still referring to FIG. 15, instead of the plurality of other closure members 12, 178, 19, 2710 being controlled by a single controller (e.g., controller 50, 2702), the plurality of other closure members 12, 17, 19, 2710 are each movable relative to the vehicle body 14 using one of the plurality of other actuators 22, 2705 in communication with and controlled by one of a plurality of other controllers 3002, 3004, 3006, 3008 each associated with one of the plurality of other closure members 12, 17, 19, 2710, according to another aspect. Each of the plurality of other controllers 3002, 3004, 3006, 3008 are configured to control movement of each of the plurality of other closure members 12, 17, 19, 2710 to compensate for the variable gravitational forces on each of the plurality of other closure members 12, 17, 19, 2710 during movement of the each of the plurality of other closure members 12, 17, 19, 2710. Again, the variable gravitational forces used to control the movement are predetermined and selected according to the position of each of the plurality of other closure members 12, 17, 19, 2710 and the steady state gravitational force from the single closure member accelerometer 86. Accordingly, the controller 50, 2702 may be configured to communicate the steady state gravitational force determined by the single closure member accelerometer 86 via a bus (e.g., CAN) communication message 3008 to each of the plurality of other controllers 3002, 3004, 3006, 3008 each associated with one of the plurality of other closure members 12, 17, 19, 2710. As a result, the part cost can be reduced.

Thus, in operation, the controller 50, 2702 and/or each of the plurality of other controllers 3002, 3004, 3006, 3008 read the steady state gravitational force or steady state gravitational force vector when the closure member 12, 17, 19, 2710 (e.g., door 12) is closed before or just as motion of the closure member 12, 17, 19, 2710 starts. The controller 50, 2702 and/or each of the plurality of other controllers 3002, 3004, 3006, 3008 then mathematically adjusts the steady state gravitational force during motion of the closure member 12, 17, 19, 2710 based on the position of the closure member 12, 17, 19, 2710. The position of the closure member 12, 17, 19, 2710 may already be a known data point based on feedback from the drive unit or actuator 22, 7052, which can be very high fidelity. The steady state gravitational force or steady state gravitational vector can be assumed to be uniform for the entire vehicle 10, meaning it only needs to be monitored once. Such an approach will allow faster processing of the output signal of the accelerometer 86, reduced duration of monitoring of the accelerometer 86, and reduction of part count on the vehicle 10.

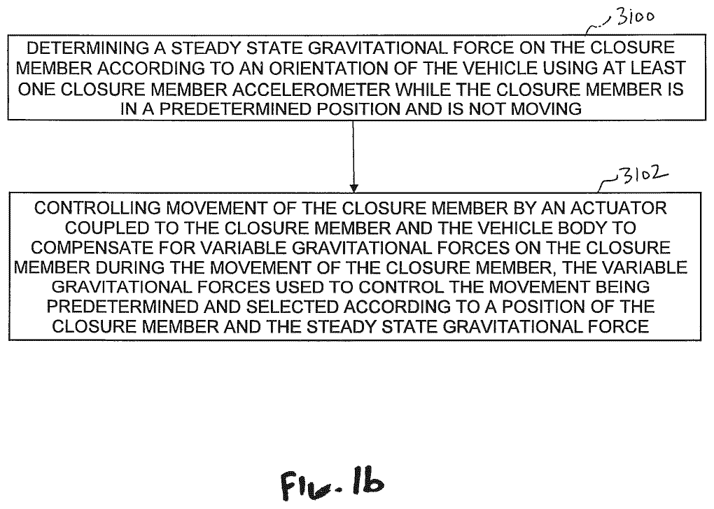

Now referring to FIG. 16, a method of controlling movement of a closure member 12, 17, 19, 2710 of a vehicle 10 between open and closed positions relative to a vehicle body 14 using a power closure member actuation system 20, 2700 is also provided. The method includes the step of 3100 determining a steady state gravitational force on the closure member 12, 17, 19, 2710 according to an orientation of the vehicle 10 using at least one closure member accelerometer (e.g., vehicle inclination sensor 86 of FIG. 5A) while the closure member 12, 17, 19, 2710 is in a predetermined position and is not moving. The method also includes the step of 3102 controlling movement of the closure member 12, 17, 19, 2710 by an actuator 22, 2705 coupled to the closure member 12, 17, 19, 2710 and the vehicle body 14 to compensate for variable gravitational forces on the closure member 12, 17, 19, 2710 during the movement of the closure member 12, 17, 19, 2710. Again, the variable gravitational forces used to control the movement are predetermined and selected according to a position of the closure member 12, 17, 19, 2710 and the steady state gravitational force.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “controller” as used in this application is comprehensive of any such computer, processor, microchip processor, integrated circuit, or any other element(s), whether singly or in multiple parts, capable of carrying programming for performing the functions, methods and flowcharts provided herein. The controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

What is claimed is:

1. A power closure member actuation system for moving a closure member of a vehicle between an open position and a closed position relative to a vehicle body, the power closure member actuation system comprising:
an actuator coupled to the closure member and the vehicle body configured to move the closure member relative to the vehicle body;
a compass;
at least one closure member accelerometer configured to determine a steady state gravitational force on the closure member according to an orientation of the vehicle; and
a controller in communication with the compass and the actuator and the at least one closure member accelerometer, the controller configured to determine a position of the closure member using the compass.

2. The power closure member actuation system as set forth in claim 1, wherein the controller is configured to determine the steady state gravitational force on the closure member using the at least one closure member accelerometer while the closure member is in a predetermined position and is not moving.

3. The power closure member actuation system as set forth in claim 2, wherein the controller is configured to control movement of the closure member by the actuator to compensate for variable gravitational forces on the closure member during movement of the closure member, the variable gravitational forces used to control the movement being predetermined and selected according to a position of the closure member and the steady state gravitational force.

4. The power closure member actuation system as set forth in claim 3, wherein the controller is configured to determine the steady state gravitational force on the closure member temporally before the closure member is moved by the actuator.

5. The power closure member actuation system as set forth in claim 4, wherein the predetermined position is the closed position of the closure member.

6. The power closure member actuation system as set forth in claim 3, further including a closure member feedback sensor configured to determine at least one of the position and a speed of the closure member.

7. The power closure member actuation system as set forth in claim 6, wherein the position of the closure member includes a plurality of positions of the closure member between the closed position and the open position and the variable gravitational forces used to control the movement include a plurality of variable gravitational force values for each of the plurality of positions of the closure member between the closed position and the open position, the plurality of variable gravitational force values predetermined through mathematical modelling prior to the controller being installed in the vehicle.

8. The power closure member actuation system as set forth in claim 6, wherein the at least one closure member accelerometer includes a single closure member accelerometer disposed on the vehicle and coupled to the controller, the vehicle includes a plurality of other closure members separate from the closure member and each movable relative to the vehicle body using one of a plurality of other actuators in communication with and controlled by the controller, the controller is configured to control movement of each of the plurality of other closure members to compensate for the variable gravitational forces on each of the plurality of other closure members during movement of the each of the plurality of other closure members the variable gravitational forces used to control the movement being predetermined and selected according to the position of each of the plurality of other closure members and the steady state gravitational force from the single closure member accelerometer.

9. The power closure member actuation system as set forth in claim 6, wherein the at least one closure member accelerometer includes a single closure member accelerometer disposed on the vehicle and coupled to the controller, the vehicle includes a plurality of other closure members separate from the closure member and each movable relative to the vehicle body using one of a plurality of other actuators in communication with and controlled by one of a plurality of other controllers each associated with one of the plurality of other closure members, each of the plurality of other controllers configured to control movement of each of the plurality of other closure members to compensate for the variable gravitational forces on each of the plurality of other closure members during movement of the each of the plurality of other closure members, the variable gravitational forces used to control the movement being predetermined and selected according to the position of each of the plurality of other closure members and the steady state gravitational force from the single closure member accelerometer.

10. The power closure member actuation system as set forth in claim 9, wherein the controller is configured to communicate the steady state gravitational force determined by the single closure member accelerometer via a bus communication message to each of the plurality of other controllers each associated with one of the plurality of other closure members.

11. The power closure member actuation system as set forth in claim 9, wherein the single closure member accelerometer is disposed on the closure member remotely from the plurality of other closure members.

12. A method of controlling movement of a closure member of a vehicle between open and closed positions relative to a vehicle body using a power closure member actuation system, comprising the steps of:
determining a steady state gravitational force on the closure member according to an orientation of the vehicle using at least one closure member accelerometer while the closure member is in a predetermined position and is not moving; and
controlling movement of the closure member by an actuator coupled to the closure member and the vehicle body to compensate for variable gravitational forces on the closure member during the movement of the closure member, the variable gravitational forces used to control the movement being predetermined and selected according to a position of the closure member and the steady state gravitational force.

13. The method as set forth in claim 12, wherein the step of determining the steady state gravitational force on the closure member according to the orientation of the vehicle using at least one closure member accelerometer while the closure member is in a predetermined position and is not moving occurs temporally before the closure member is moved by the actuator.

14. A control system for power closure member actuation system for moving a closure member of a vehicle between an open position and a closed position relative to a vehicle body, the control system comprising:
a controller configured to control an actuator coupled to the closure member and the vehicle body configured to move the closure member relative to the vehicle body;
a closure member accelerometer configured to output an accelerometer signal to the controller indicative of an inclination of the closure member;
wherein the controller is adapted to compensate for a change in the inclination of the closure member during controlling the actuator to move the closure member using the accelerometer signal acquired during a steady state of the closure member.

15. The control system of claim 14, wherein the controller is adapted to compensate for the change in the inclination of the closure member during controlling the actuator to move the closure member using the accelerometer signal acquired while the closure member is not in motion.

16. The control system of claim 14, wherein the closure member accelerometer is not positioned on the closure member.

17. The control system of claim 16, wherein the closure member accelerometer is positioned on the vehicle body and the accelerometer signal to the controller is indicative of an inclination of the vehicle body.

18. The control system of claim 14, wherein the closure member includes a plurality of closure members and the power closure member actuation system includes more than one power closure member actuation system for the vehicle and the controller includes a plurality of controllers, the more than one power closure member actuation system each configured to move one of the plurality of closure members of the vehicle and each including one of the plurality of controllers, wherein each of the plurality of controllers is adapted to use the accelerometer signal.

19. The control system of claim 18, wherein each of the plurality of controllers is adapted to use the accelerometer signal from the same closure member accelerometer.

20. The control system of claim 14, wherein the controller is configured to determine a change in the inclination of the closure member using the accelerometer signal acquired during a steady state of the closure member and a position of the closure member during the actuator moving the closure member.
